(19) United States
(12) Patent Application Publication
(10) Pub. No.: US 2025/0266574 A1
(43) Pub. Date: Aug. 21, 2025

(54) SEPARATOR FOR A BATTERY

(71) Applicant: FORD GLOBAL TECHNOLOGIES, LLC, Dearborn, MI (US)

(72) Inventors: Gang GUO, Saline, MI (US); Claudia JAZOWSKI, Ferndale, MI (US)

(21) Appl. No.: 18/443,693

(22) Filed: Feb. 16, 2024

(51) Int. Cl. H01M 50/451; H01M 50/406; H01M 50/414; H01M 50/434

(52) U.S. Cl. CPC H01M 50/451; H01M 50/406; H01M 50/414; H01M 50/434

(57) ABSTRACT

A battery with a negative electrode assembly, a positive electrode assembly, and a separator is presented. The separator includes a substrate having an end-coated region with an electrically insulative coating thereon and a body region that lacks the electrically insulative coating, disposed between the negative and positive assemblies such that the body region is between the negative and positive electrode assemblies and the end-coated region extends beyond an adjacent active material end of at least one of the assemblies to form a physical barrier that prevents penetration of the end-coated region due to bending deformation of a current collector of one of the negative and positive assemblies.

### TECHNICAL FIELD

In at least one aspect, separators for lithium-ion batteries are provided.

### BACKGROUND

Lithium-ion batteries, used in various technologies, may have internal shorts under certain conditions. Various factors contribute to internal shorts, with a cause being the contact between anode and cathode materials. Such contact, potentially occurring between current collectors and electrodes, arises under certain conditions.

### SUMMARY

In one aspect of the disclosure, a battery with a negative electrode assembly, a positive electrode assembly, and a separator, which includes a substrate with an end-coated region having an electrically insulative coating and a body region lacking this coating, situated between the negative and positive assemblies is presented. The body region of the substrate may be positioned between the negative and positive electrode assemblies, while the end-coated region of the substrate extends beyond an adjacent active material end of at least one of the assemblies, forming a physical barrier to prevent penetration due to bending deformation of a current collector from either the negative or positive assemblies. The electrically insulative coating on the battery's separator's end-coated region may be a polymer. In some configurations, the electrically insulative coating may specifically be a polymer film. The end-coated region of the separator may be thicker than the body region. Alternatively, in some configurations, the end-coated region may be coated with a ceramic. In some configurations, the ceramic applied to the end-coated region is Al₂O₃. The thickness of the body region of the separator in some configurations is between 8 and 12 microns, and the thickness of the substrate with the end-coated region in some configurations is between 12 and 18 microns.

In another aspect of the disclosure, a battery with a pair of electrode assemblies, each including a current collector with active material and a tab extending away from the active material, and a separator with an electrically insulative coated end and an uncoated body, positioned between the assemblies is presented. The electrically insulative coated end of the separator is adjacent to and between the tabs, preventing penetration during bending deformation of at least one of the tabs. In some configurations, the electrically insulative coating on the separator's coated end may be a polymer. The polymer in some configurations may specifically be a polymer film. In some configurations, the electrically insulative coated end of the separator may be thicker than the body region. The electrically insulative coated end may be coated with a ceramic. In some configurations, the ceramic may be Al₂O₃. The thickness of the body region of the separator may be between 8 and 12 microns. The thickness of the separator with the electrically insulative coated end may be between 12 and 18 microns.

In yet another aspect of the disclosure, a manufacturing method is presented. The manufacturing method involves extruding an electrically insulative polymer film to form a separator sheet with ends thicker than the body between the ends, creating a dog bone profile. This separator sheet may be configured to be placed between electrode assemblies of a battery cell, where the ends act as a physical barrier to prevent shorting between tabs of the assemblies due to bending deformation of at least one of the tabs toward one of the ends. The ends of the separator sheet may be coated with an electrically insulative material. In some configurations of this method, the ends of the separator may be coated with a ceramic. In some configurations of this method, the ends of the separator may be coated with Al₂O₃.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A is a schematic view, in cross-section, of a positive electrode that includes cathode active material on a single side of a current collector;

FIG. 1B is a schematic view, in cross-section, of a positive electrode that includes cathode active material on both sides of a current collector;

FIG. 2A is a schematic view, in cross-section, of a battery;

FIG. 2B is a schematic view, in cross-section, of a battery;

FIG. 3A is a schematic view, in cross-section, of a battery according to one aspect of the disclosure;

FIG. 3B is a schematic view, in cross-section, of a battery according to one aspect of the disclosure;

FIG. 4A is a schematic view, in cross-section, of a battery according to one aspect of the disclosure;

FIG. 4B is a schematic view, in cross-section, of a battery according to one aspect of the disclosure; and

FIG. 5 is a flowchart of an assembly process according to one embodiment.

### DETAILED DESCRIPTION

Reference will now be made in detail to compositions, embodiments, and methods of the present invention. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary, when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refer to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It should be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value. As used herein, the term “and/or” means that either all or only one of the elements of said group may be present. For example, “A and/or B” shall mean “only A, or only B, or both A and B.” In the case of “only A,” the term also covers the possibility that B is absent, i.e. “only A, but not B.”

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The phrase “composed of” means “including” or “consisting of.” Typically, this phrase is used to denote that an object is formed from a material. With respect to the terms “comprising,” “consisting of,” and “consisting essentially of,” where one of these three terms is used herein, the presently disclosed and claimed subject matter can include the use of either of the other two terms. The term “one or more” means “at least one” and the term “at least one” means “one or more.” The terms “one or more” and “at least one” include “plurality” and “multiple” as a subset. In a refinement, “one or more” includes “two or more.” The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1, the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

The term “positive electrode” means a battery cell electrode from which current flows out when the lithium-ion battery cell or battery is discharged. Sometimes a “positive electrode” is referred to as a “cathode.” The term “negative electrode” means a battery cell electrode to which current flows in when the lithium-ion battery cell is discharged. Sometimes a “negative electrode” is referred to as an “anode.” The term “cell” or “battery cell” means an electrochemical cell made of at least one positive electrode, at least one negative electrode, an electrolyte, and a separator membrane. The term “battery” or “battery pack” means an electric storage device made of at least one battery cell. In a refinement, “battery” or “battery pack” is an electric storage device made of a plurality of battery cells.

In lithium-ion batteries, maintain longevity of battery cells may be a factor in performance. In standard lithium-ion battery cells, the anode electrode typically has a larger surface area compared to the cathode electrode. The arrangement involves connecting cathode current collectors from electrode layers to form a cohesive cathode tab. A similar assembly process may be used for connecting anode current collectors, so as to form an anode tab. Separator layers are generally positioned between the anode and cathode materials. The separator layers extend beyond the edges of the electrodes, providing some insulation between the anode and cathode, acting to prevent direct electrical contact and subsequent short-circuiting. However, the separator layers may be susceptible to penetration by external forces.

Under specific conditions, such as the application of external force to the tab area, there may be deformation. This deformation may lead to a bending of the cathode or anode tabs towards an opposite electrode zone. Given the physical properties of the separator layer, the bending may compromise the integrity of the film, which may result in inadvertent contact between cathode and anode materials. This unintended contact may be a precursor to internal short circuits.

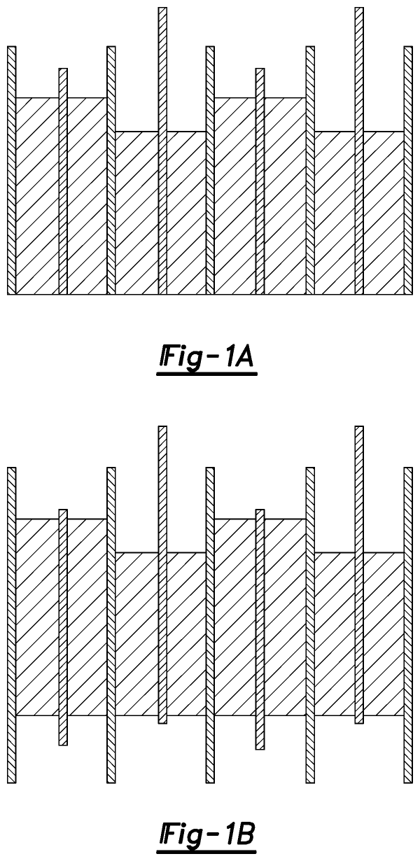

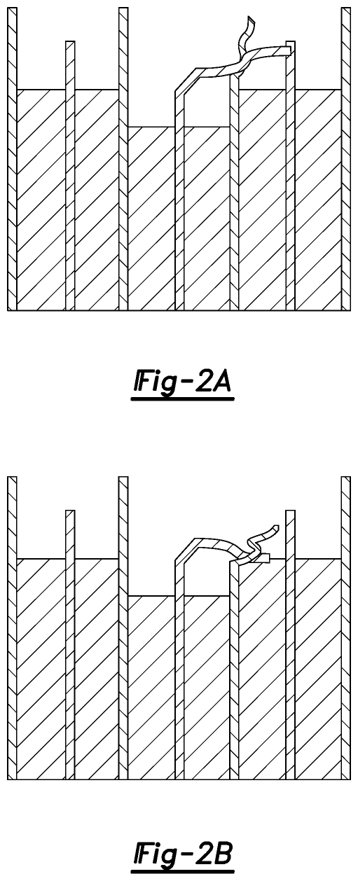

FIGS. 1A-2B illustrate schematic views of lithium-ion battery cell structures. In each respective cell, cathode current collectors across electrode layers of the cell are joined to form a cathode tab, mirroring the anode current collectors form the anode tab. In FIG. 1A, the anode and the cathode tabs extend out from the same side of the battery cell. Whereas, in FIG. 1B, the anode and the cathode tabs extend out from opposite sides of the battery cell.

In specific instances, such as when an external force contacts the tab area of a battery, deformation may occur in the tab and its connected current collectors. As illustrated in FIG. 2A, this scenario may cause a cathode tab to bend towards the anode assembly. Given the separator's composition this bending of the cathode current collector poses a potential of affecting the mechanical integrity of the separator, which, while positioned between, is not attached to the electrodes. Consequently, this could lead to direct contact with the anode electrode or its current collector. A parallel situation is depicted in FIG. 2B, where bending of the anode tab and current collector may similarly compromise the separator and result in contact with the cathode current collector or electrode.

The present disclosure relates to the insulation capabilities of a separator in a battery through fortification. By reinforcing a part or portion of the separator film that lies beyond the immediate electrode area an electrically insulative end-coated region may be created. The end-coated region is formed to prevent penetration of the separator when the tab or current collector is subject to bending. This may reduce the instances of a deformed current collector breaching or penetrating the separator and contacting the opposing electrode materials. It is to be understood that the described fortification of the separator is applicable to any type of battery cell, including but not limited to lithium-ion battery cells. This includes various cell configurations such as prismatic, cylindrical, pouch, and other commercially available or future-developed battery cell designs.

The end-coated region of the separator may be formed in such a way so that it is constrained only to the portion of the separator film extending beyond the anode and cathode materials. This allows the end-coated region to fortify the properties of the separator at an exposed section while maintaining characteristics of the cell, such as its structure, chemical composition, and energy density. Several methods may be used to create this end-coated region of the separator. In one example, the extended section of the separator film may be coated with insulating materials. These materials may include high-temperature-resistant polymers or ceramics, which offer increased durability with resistance to puncture and tearing. In another example, during a manufacturing process, a thicker portion of the separator may be extruded specifically in an exposed area of a separator extending beyond a battery assembly to create the electrically insulative region. In another example, an additional layer of film, selected for its material properties such as high tensile strength and insulating capabilities, may be applied to an extended section of the separator. The end-coated region may be applied unilaterally or bilaterally on the separator film and may be implemented at one or both ends of the separator, depending on the orientation of the tabs of the battery. In addition to high-temperature-resistant polymers or ceramics, other potential materials for the insulative material may include but are not limited to advanced composite materials, nanomaterials, and other electrically insulative compounds that offer enhanced puncture and tear resistance. The polymer film may also be composed of various advanced polymer composites, tailored elastomers, or other synthetic materials designed to provide optimal insulation and mechanical protection.

In the context of manufacturing various types of battery cells, including lithium-ion prismatic, cylindrical, pouch, or others, the end-coated region may be added to a separator film at the early stages of the cell assembly process. The end-coated region is preferably applied before the electrodes are stacked with the separator and prior to any folding of the electrodes with the separator. Creating the end-coated region prior to subsequent processing steps may help in maintaining uniformity of the individual cells. Additionally, it may streamline production assembly efficiency reducing the need for later-stage rework or adjustments. Further, this sequence of application may allow easier verification that the enhancement is applied to specification before full assembly.

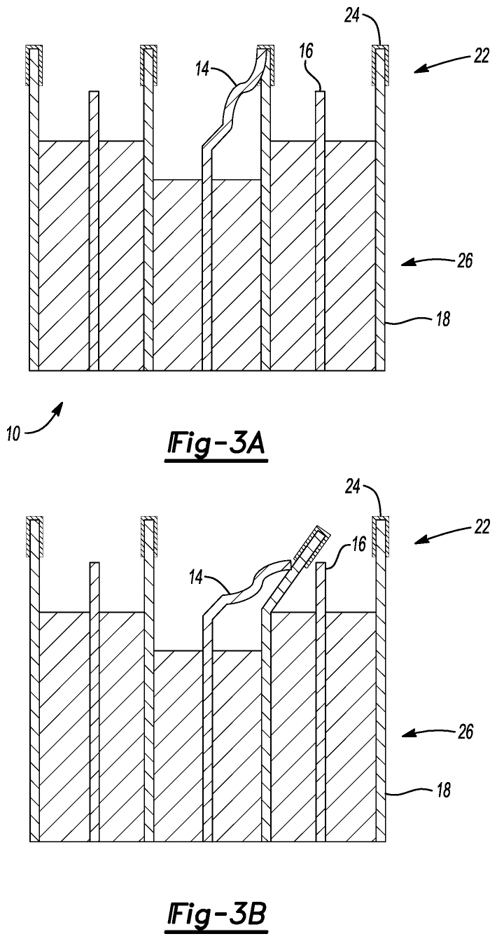

In FIGS. 3A-B, a battery pack 10 with multiple cells is presented. In cell 12 of the battery pack 10, a negative electrode assembly 14, a positive electrode assembly 16, and a separator 18 are assembled. The separator 18 includes a substrate 20. The substrate 20 has two distinct regions. An end-coated region 22, with an electrically insulative coating 24, and a body region 26, which lacks this coating. The separator 18 is positioned between the negative 14 and positive 16 electrode assemblies in a manner that places the body region 26 directly between them. The end-coated region 22, extends beyond an adjacent active material end of at least one of the negative 14 or positive 16 electrode assemblies. The end-coated region serves as a physical barrier. The barrier provided by the end-coated region 22 is generally impermeable to penetration in scenarios where bending deformation of either the negative 14 or positive 16 electrode assemblies may occur, as shown in prior art FIGS. 2A-B.

FIG. 3B, illustrates the separator 18 under conditions of mechanical stress, such as when a current collector from the negative electrode assembly 14 or positive electrode assembly 16 is subjected to bending. The end-coated region 22 with its insulative coating 24 maintains structural integrity and prevents any breach or contact with the opposing electrode assembly, thereby mitigating potential short circuits.

To form the separator 18 the electrically insulative coating 24 is applied to the end-coated region 22, while keeping the body region 26 uncoated. The electrically insulative coating 24 coating may be applied through various methods, including applying a polymer film or a ceramic-based substance such as Al₂O₃, to the end-coated region 22. In some configurations the portion of the substrate 20 in the end-coated region 22 may be thicker than the body region 26, adding to the robustness of the physical barrier. In other configurations, the end-coated region 22 of the substrate 20 may be a thicker portion of the same material that comprises the separator 18. This may be achieved by extrusion of additional material at the end-coated region 22. This additional material may be extruded in such a manner to form a “dog bone” profile. This profile is defined by the body region 26 of the substrate 20 framed by the end-coated region 22 of the substrate 20.

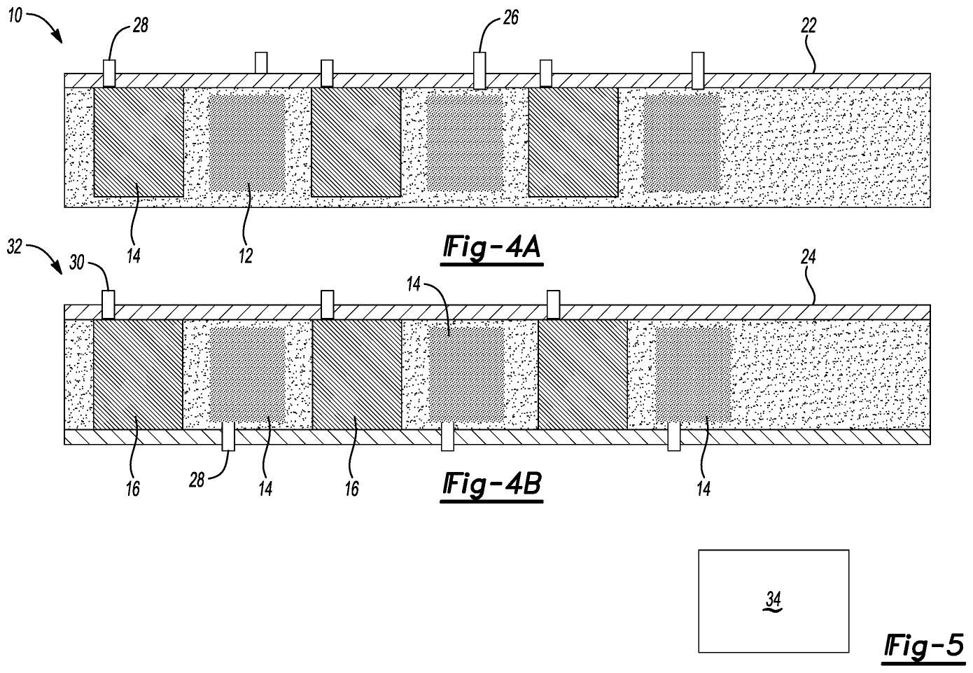

In FIGS. 4A-4B, the electrically insulative coating 24 is applied to the end-coated region 22 on one side of the separator 18, adjacent to either the anode tab 28 or cathode tab 30 of the battery 10. FIG. 4B, illustrates a battery pack 32 in another configuration where the electrically insulative coating 24 is applied to both ends of the separator 18. In this configuration the tabs of the anode 14 and cathode 16 assemblies are on opposite sides. This allows the electrically insulative coating 24 to act as reinforced ends of the separator 16 and as effective barriers against short circuits under bending force.

FIG. 5 illustrates a flowchart of a manufacturing method for a separator. The method 34 includes extruding an electrically insulative polymer film, to form a separator sheet with a “dog bone” profile. A dog bone profile is characterized by its ends which are thicker than the body region between them. The extruded separator sheet, with its thicker ends, is then configured to be placed between the electrode assemblies of a battery cell. In this configuration, the thicker ends of the separator sheet extend beyond the adjacent active material ends of at least one electrode assembly placed with the separator. The thicker ends of the separator sheet act as a physical barrier within the battery cell.

The primary function of this physical barrier is to prevent electrical shorting between the tabs of the electrode assemblies. This prevention is particularly important in scenarios where there is bending deformation of one or more of the tabs towards the ends of the separator. In such instances, the thicker ends of the separator sheet provide a layer of protection, effectively mitigating the potential of short circuits.

The reinforcements of end-regions of a separator described may be compatible across various battery chemistries, including but not limited to lithium manganese rich (LMR), nickel cobalt manganese (NCM), lithium iron phosphate (LFP), and other advanced electrode materials. The design and application of the electrically insulative coating, as well as the “dog bone” profile of the separator, are intended to be adaptable across these different chemistries. The addition of the reinforcements may reduce the potential occurrence of electrical shorts within the battery, by preventing the contact between electrode assemblies under mechanical stress or deformation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A battery comprising:
a negative electrode assembly;
a positive electrode assembly; and
a separator, including a substrate having an end-coated region with an electrically insulative coating thereon and a body region that lacks the electrically insulative coating, disposed between the negative and positive electrode assemblies such that the body region is between the negative and positive electrode assemblies and the end-coated region extends beyond an adjacent active material end of at least one of the negative and positive electrode assemblies to form a physical barrier that prevents penetration of the end-coated region due to bending deformation of a current collector of one of the negative and positive electrode assemblies.

2. The battery of claim 1 wherein the coating is a polymer.

3. The battery of claim 2 wherein the coating is a polymer film.

4. The battery of claim 1 wherein the end-coated region is thicker than the body region.

5. The battery of claim 1 wherein the end-coated region is coated with a ceramic.

6. The battery of claim 1 wherein the end-coated region is coated with Al₂O₃.

7. The battery of claim 1 wherein a thickness of the body region is between 8 and 12 microns.

8. The battery of claim 1 wherein a thickness of the end-coated region is between 12 and 18 microns.

9. A battery comprising:
a pair of electrode assemblies each including a current collector defining an active region having active material thereon and a tab extending away from the active material; and
a separator, having an electrically insulative coated end and an uncoated body, disposed between the pair such that the electrically insulative coated end is adjacent to and in-between the tabs to prevent penetration of the separator during bending deformation of at least one of the tabs.

10. The battery of claim 9 wherein electrically insulative coating on the electrically insulative coated end is a polymer.

11. The battery of claim 10 wherein the electrically insulative coating is a polymer film.

12. The battery of claim 9 wherein the electrically insulative coated end thicker than the uncoated body.

13. The battery of claim 9 wherein the electrically insulative coated end is coated with a ceramic.

14. The battery of claim 9 wherein the electrically insulative coated end is coated with Al₂O₃.

15. The battery of claim 9 wherein a thickness of the uncoated body is between 8 and 12 microns.

16. The battery of claim 9 wherein a thickness of the electrically insulative coated end is between 12 and 18 microns.

17. A manufacturing method comprising:
extruding an electrically insulative polymer film to form a separator sheet having ends that are thicker than a body between the ends to define a dog bone profile, and configured to be disposed between electrode assemblies of a battery cell such that the ends define a physical barrier that prevents shorting between tabs of the electrode assemblies due to bending deformation of at least one of the tabs toward at least one of the ends.

18. The manufacturing method of claim 17 wherein the ends are coated with an electrically insulative material.

19. The manufacturing method of claim 17 wherein the ends are coated with a ceramic.

20. The manufacturing method of claim 17 wherein the ends are coated with Al₂O₃.
